(19) United States
(12) Patent Application Publication
(10) Pub. No.: US 2008/0169753 A1
(43) Pub. Date: Jul. 17, 2008

(54) LIGHT EMISSIVE PRINTED ARTICLE PRINTED WITH QUANTUM DOT INK

(75) Inventors: Andrew F. Skipor, West Chicago, IL (US); Krishna D. Jonnalagadda, Algonquin, IL (US); Krishna Kalyanasundaram, Elmhurst, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/622,215

(22) Filed: Jan. 11, 2007

(51) Int. Cl. H01J 1/62

(52) U.S. Cl. 313/504; 313/503; 977/950

(57) ABSTRACT

A light emissive printed articles (101) include printing with ink that includes quantum dots in lieu of pigment. A pump light that emits light with photon energies sufficient to excite the quantum dot ink (102) is used to drive light emission.

### FIELD OF THE INVENTION

The present invention relates to light emissive printed articles.

### BACKGROUND

In today's competitive global market manufacturers and retailers must compete for consumers attention in an increasingly competitive environment. One form of advertisement uses posters. However, posters may not make much of an impression on consumers accustomed to high definition flat screen TV and computer displays. In order to make posters more memorable posters that include electroluminescent lamps that are patterned to show lighted areas of a product have been introduced. For example there are posters that use electroluminescent lamps as the lighted display of depicted cellular telephones. Electroluminescent lamps use multilayer structures that requires specialized equipment and techniques to manufacture them and so can not readily be made by local printers for use in a local retail market. Moreover, given the broad spectrum of electroluminescent lamps, finely tuned colors which are important for advertising materials can not be obtained without the added complexity of overlaid filters, which in any case would reduce brightness.

Thus, there is a need for luminescent posters with a broad color range and a simplified structure that lends itself to rapid production.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a schematic of a light emissive poster system including a light emissive poster printed with quantum dot ink and a pump light;

FIG. 2 is a schematic cross section of a functionalized core-shell quantum dot used in the ink of the light emissive poster shown in FIG. 1;

FIG. 3 is a schematic sectional elevation view of a quantum dot light emitting device that is used as the pump light shown in FIG. 1 according to an embodiment of the invention;

FIG. 4 is a schematic of a fluorescent lamp light box that is used as the pump light shown in FIG. 1 according to an alternative embodiment of the invention;

FIG. 5 is a graph including plots of quantum dot absorbance versus wavelength for several sizes of quantum dots;

FIG. 6 is a graph including three lines of spectral emission for three size distributions of quantum dots;

FIG. 7 is a 1931 CIE chart showing a color range obtainable by mixing quantum dots of the three distributions have the spectral emissions shown in FIG. 6;

FIG. 8 a schematic cross section of a light emissive poster including an ink including quantum dots and a UV transparent overcoating; and

FIG. 9 shows a product package with a light emissive label that is printed with ink that includes quantum dots.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of and apparatus components related to quantum dot light emissive poster systems. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

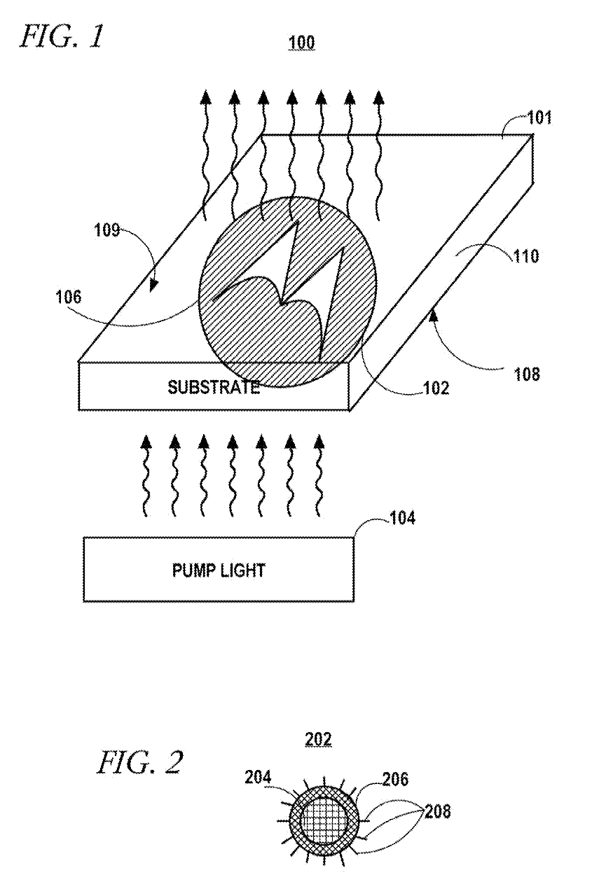

FIG. 1 is a schematic of a light emissive poster system 100 including a light emissive poster 101 printed with quantum dot ink 102 and a pump light 104. Printed graphics 106 include the quantum dot ink 102. The printed graphics 106 are printed on a backside 108 (a side that faces away from a viewer) of a substrate 110. The pump light 104 is arranged to illuminate the printed graphics 106. Alternatively, the printed graphics 106 are printed on a front side 109 of the substrate 109 and the pump light is positioned facing the front side 109. The pump light 104 emits ultraviolet and/or visible light including photons that have photon energies greater than a band gap of quantum dots (202, FIG. 2) in the quantum dot ink 102. Accordingly illuminating the printed graphics 106 with the pump light 104 causes the quantum dot ink 102 to emit light. Other graphics (not shown) that are not printed with the quantum dot ink 102 can also be printed on the substrate 108, so that only a portion of the poster 101 will be light emissive. The substrate 110 can be made out of a material, e.g., transparent plastic, that absorbs light (e.g., ultraviolet light) emitted by the pump light. The substrate 110 can be made out of a flexible and conformable material so that the poster 101 can be displayed in a non-planar configuration. Using a separate pump light 104 and poster 101 facilitates local design and printing of the poster 101. The poster 101 can be used in a scrollable display, such as used for advertising.

Multiple colors of quantum dot ink 102, each of which is characterized by a different band gap mean and peak color can be used so that the light emissive poster 101 will include multi-color light emissive printing.

FIG. 2 is a schematic cross section of a functionalized core-shell quantum dot 202 used in the ink of the light emissive poster shown in FIG. 1. The quantum dot 202 includes a core 204 and a shell 206. The shell 206 is made of a material that has a higher band gap than a material of the core 204. Using a higher band gap shell reduces a rate of non-radiative transitions thereby increase the efficiency and brightness of the quantum dot ink 102. The core 204 can, for example, be made of CdS, CdSe, CdTe, ZnS, ZnSe, ZnTe, GaAs, GaP, GaAs, GaSb, HgS, HgSe, HgTe, InAs, InP, InSb, AlAs, AIP, AlSb, whilst the shell 206 can, for example be made of ZnO, ZnS, ZnSe, ZnTe, CdO, CdS, CdSe, CdTe, MgS, MgSe, GaAs, GaN, GaP, GaAs, GaSb, HgO, HgS, HgSe, HgTe, InAs, InN, InP, InSb, AlAs, AlN, AIP, AlSb. Alternative quantum dot materials that may be used include but are not limited to tertiary microcrystals such as InGaP, which emits in the yellow to red wavelengths (depending on the size) and ZnSeTe, ZnCdS, ZnCdSe, and CdSeS which emits from blue to green wavelengths, (depending upon the size). Additional alternative materials that may be used in quantum dots include Zinc chalcogenides, such as ZnSe, doped with transition metal ions such as Mn or Cu. The quantum dot 202 is capped (functionalized) with organic molecules 208. In as much as quantum dots are prepared in colloidal systems a variety of molecules can be attached to them via metal coordinating functional groups, including thiols, amines, nitrites, phosphines, phosphine oxides, phosphonic acids, carboxylic acids or others ligands. With appropriate molecules bonded to the surface, the quantum dots could be readily included in different ink systems, without degrading their quantum electronic properties (e.g., emission efficiency). The organic molecules 208 render the quantum dot miscible with an organic resin and solvent of the quantum dot ink 102. The quantum dot ink 102 can be heat dryable or include a UV curable photochemical resin, for example.

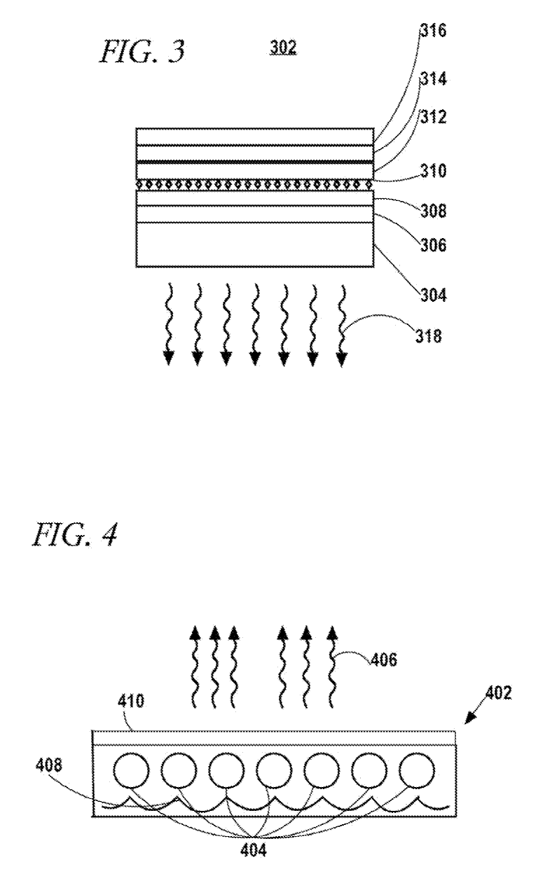

FIG. 3 is a schematic sectional elevation view of a quantum dot light emitting device 302 that is used as the pump light 104 shown in FIG. 1 according to an embodiment of the invention. The quantum dot light emitting device 302 includes a multilayer structure including, in sequence, a substrate (e.g., glass) 304, a transparent conductor (e.g., ITO) 306, an organic or inorganic hole transport layer (e.g., N,N0-diphenyl-N,N0-bis(3-methylphenyl)-(1,10-biphenyl)-4,40-diamine (TPD)) 308, a quantum dot layer 310, an organic or inorganic electron transport layer (e.g., tris-(8-hydroxyquinoline)aluminum or 3-(4-Biphenylyl)-4-phenyl-5-tert-butylphenyl-1, 2, 4-triazole (TAZ)) 312, an electron source layer (e.g., Mg:Ag) 314 and an electrical contact (e.g. Ag) 316. The light emitting device 302 emits photons 318 Alternatively, light emitting diodes that do not include quantum dots can be used. For example a GaN UV diodes can be used.

FIG. 4 is a schematic of a fluorescent lamp light box 402 that is used as the pump light 104 shown in FIG. 1 according to an alternative embodiment of the invention. The light box 402 includes a number of fluorescent light bulbs 404, such as those used in tanning beds or black lights, that emit UV light 406. A back reflector 408 is used to collect and direct the UV light 406 emitted by the bulbs 404. The UV light 406 passes out of the light box 402 through a protective window 410 that is made out of a UV transmissive material such as borosilicate glass or UV transmissive plastic such as a UV transmissive acrylic polymer such as Acrylite® H12-503 manufactured by Cyro Industries of Rockaway, N.J. According to an alternative embodiment of the invention a compact pump lamp such as a medium pressure arc lamp is used to illuminate the light emissive poster 101.

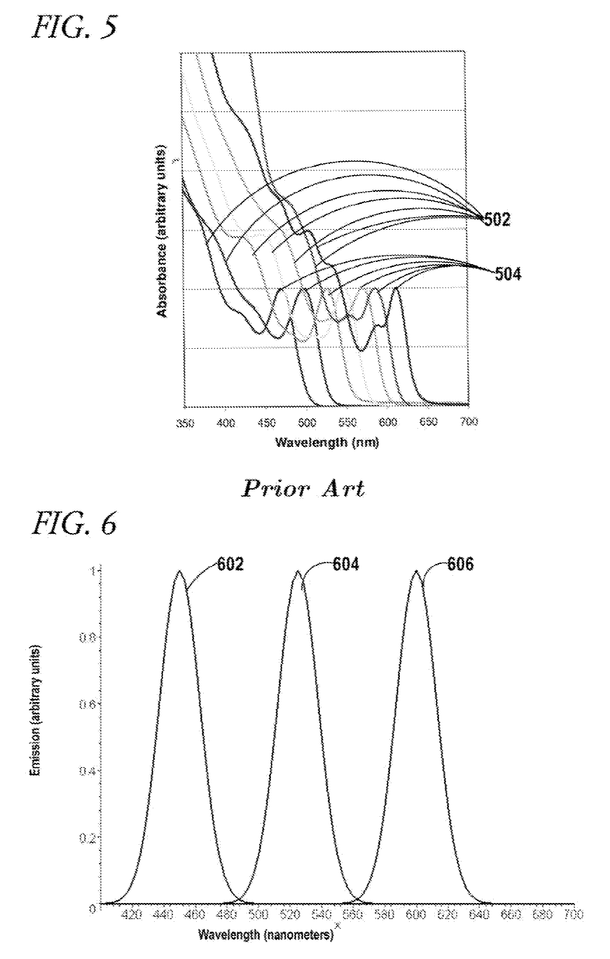

FIG. 5 is a graph including plots 502 quantum dot absorbance versus wavelength for several sizes of quantum dots 202 that emit visible light. The plots 502 are for different sizes of quantum dots 202. Each plot 502 includes a local peak 504 that corresponds to its peak emission wavelength. As shown in FIG. 5 all of the quantum dots 202 represented in the plots 502 are able to effectively absorb pump light in the UVA range

FIG. 6 is a graph including three lines 602, 604, 606 of spectral emission for three size distributions of quantum dots. The lines 602, 604, 606 exhibit Gaussian line shapes that have a FWHM of 30 nm. The spectral FWHM is a function of the size distribution FWHM. A first blue line 602, is centered at 450 nm, a second green line 604 is centered at 525 nanometers and a third red line 606 is centered at 600 nanometers.

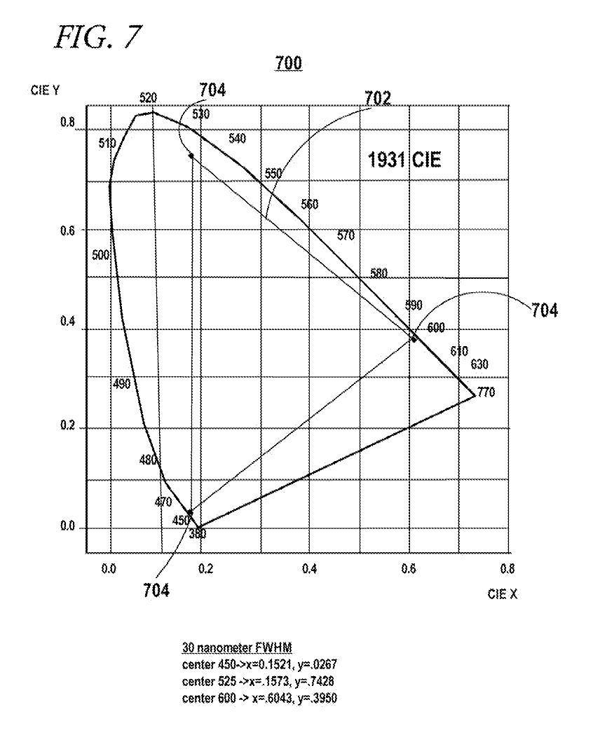

FIG. 7 is a 1931 CIE chart 700 showing a color range 702 obtainable by mixing quantum dots of the three distributions have the spectral emissions shown in FIG. 6. One skilled in the art will appreciate that the use of quantum dots allows for fine control of the obtainable color space by controlling the center and FWHM of quantum dot size distributions used in the quantum dot ink 102. Although as shown in FIG. 7 only three color space points 704 are used to delineate the obtained color range 702, one skilled in the art will appreciate that an expanded color range can be obtained by using more than three quantum dot inks, with each ink having a different mean quantum dot size. A variety of printing techniques, such as for example Flexo, Gravure, Screen, inkjet can be used. The Halftone method, for example, allows the full color range 702 to be realized in actual printing.

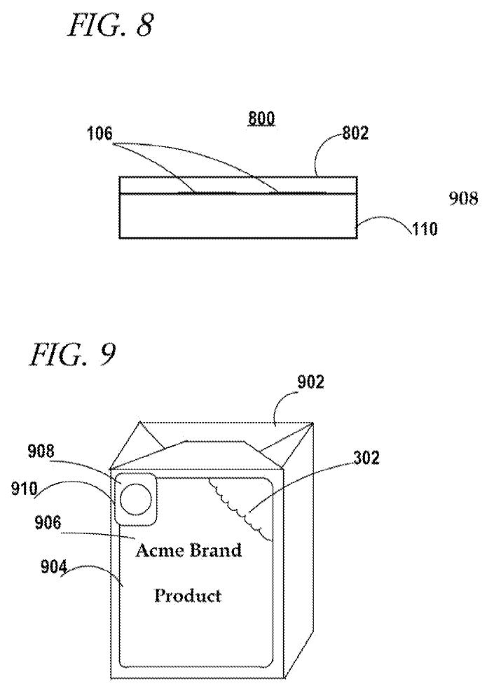

FIG. 8 a schematic cross section of a light emissive poster 800 according to an alternative embodiment. The light emissive poster 800 includes a UV transparent coating 802 covering the printed graphics 106, so that the printed graphics 106 are disposed between the substrate 110 and the UV transparent coating 802. The UV transparent coating can for example be a UV transmissive acrylic polymer such as Acrylite® H12-503 manufactured by Cyro Industries of Rockaway, N.J. The photons 318 and UV light 406 can activate the printed graphics 106 through the UV transparent coating 802. The coating 802 serves to seal and protect the printed graphics 106.

For some applications, the poster 101 can be affixed to another object, such as for example, a carton or a container. Elongated quantum dot rods, which emit polarized light may be used. Elongated quantum dot rods are disclosed by Liang-shi Li, J. Hu, W. Yang, and A. Paul Alivisatos in Nano Letters, 2001, Vol. 1 No. 7 pp 349-351.

FIG. 9 shows a product package 902 with a light emissive label 904 with printing 906 with quantum dot ink. The label overlies the pump light source 302 which is supported on the package 902. A battery 908 in a battery case 910 is electrically coupled to and supplies electrical power to the pump light source

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A light emissive printed article comprising:
a substrate; and
a pattern of ink comprising quantum dots printed on said substrate, wherein said quantum dots are characterized by a plurality of energy band gaps corresponding to visible light wavelengths.

2. The light emissive printed article according to claim 1 wherein:
said quantum dots comprise:
a core; and
a shell.

3. The light emissive printed article according to claim 1 wherein said quantum dots comprise one or more materials selected from the group consisting of: CdS, CdSe, CdTe, ZnS, ZnSe, ZnTe, GaAs, GaP, GaAs, GaSb, HgS, HgSe, HgTe, InAs, InP, InSb, AlAs, AIP, AlSb, ZnO, ZnS, ZnSe, ZnTe, CdO, CdS, CdSe, CdTe, MgS, MgSe, GaAs, GaN, GaP, GaAs, GaSb, HgO, HgS, HgSe, HgTe, InAs, InN, InP, InSb, AlAs, AlN, AlP, AlSb, ZnSeTe, ZnCdS, ZnCdSe, CdSeS, ZnSe doped with Mn and ZnSe doped with Cu.

4. The light emissive printed article according to claim 1 wherein:
said quantum dots are functionalized with organic molecules.

5. The light emissive printed article according to claim 4 wherein
said pattern of ink comprises a photochemical resin, and said organic molecules are miscible with said photochemical resin.

6. A light emissive printed article system comprising:
a light emissive printed article comprising:
a substrate; and
a pattern of ink comprising quantum dots printed on said substrate, wherein said quantum dots are characterized by a plurality of energy band gaps corresponding to visible light wavelengths; and
a source of light arranged so as to illuminate said pattern of ink, wherein said source light emits light with photon energies greater than said energy band gaps.

7. The light emissive printed article system according to claim 6 wherein:
said quantum dots comprise:
a core; and
a shell.

8. The light emissive printed article system according to claim 6 wherein:
said quantum dots are functionalized with organic molecules.

9. The light emissive printed article system according to claim 8 wherein
said pattern of ink comprises a photochemical resin, and said organic molecules are miscible with said photochemical resin.

10. The light emissive printed article system according to claim 6 wherein:
said source of light comprises a semiconductor device.

11. The light emissive printed article system according to claim 10 wherein:
said semiconductor device comprise a light emitting diode.

12. The light emissive printed article system according to claim 6 wherein:
said source of light comprises quantum dots.

13. The light emissive printed article system according to claim 12 wherein:
said quantum dots of said source of light are disposed between an organic hole transport layer and an organic electron transport layer.

14. The light emissive printed article system according to claim 6 wherein:
said source of light comprises a fluorescent lamp.

15. The light emissive printed article system according to claim 6 comprising:
a viewed surface that faces a viewer of said printed article;
wherein said source of light emits UV light;
wherein said substrate is transmissive of visible light having said visible light wavelengths and said substrate blocks said UV light.

16. A product package comprising:
a pump light supported on the package;
a label printed with ink comprising quantum dots overlying the pump light; and
a battery supported coupled to said pump light.

17. The product package according to claim 16 wherein:
said quantum dots comprise:
a core; and
a shell.

18. The product package according to claim 16 wherein said quantum dots comprise one or more materials selected from the group consisting of:
CdS, CdSe, CdTe, ZnS, ZnSe, ZnTe, GaAs, GaP, GaAs, GaSb, HgS, HgSe, HgTe, InAs, InP, InSb, AlAs, AIP, AlSb, ZnO, ZnS, ZnSe, ZnTe, CdO, CdS, CdSe, CdTe, MgS, MgSe, GaAs, GaN, GaP, GaAs, GaSb, HgO, HgS, HgSe, HgTe, InAs, InN, InP, InSb, AlAs, AlN, AlP, AlSb, ZnSeTe, ZnCdS, ZnCdSe, CdSeS, ZnSe doped with Mn and ZnSe doped with Cu.

19. The product package according to claim 16 wherein:
said quantum dots are functionalized with organic molecules.

20. The product package according to claim 16 wherein:
said ink comprises a photochemical resin, and said organic molecules are miscible with said photochemical resin.
